(19) United States
(12) Patent Application Publication
(10) Pub. No.: US 2024/0337295 A1
(43) Pub. Date: Oct. 10, 2024

(54) BRAKE CALIPER FOR A VEHICLE BRAKE

(71) Applicant: ZF CV Systems Europe BV, Brussels (BE)

(72) Inventors: Jannis Hecker, Heidelberg (DE); Vitalij Scherer, Leimen (DE)

(21) Appl. No.: 18/580,677

(22) PCT Filed: Jun. 21, 2022
(86) PCT No.: PCT/EP2022/066861

§ 371 Date: Jan. 19, 2024

(30) Foreign Application Priority Data
Jul. 21, 2021 (DE) 10 2021 118 890.3

(51) Int. Cl. F16D 65/00; F16D 55/00; F16D 55/2265

(52) U.S. Cl. CPC F16D 65/0087; F16D 55/22655; F16D 2055/0016; F16D 2055/007; F16D 65/0068; F16D 2200/0004; F16D 2200/0056

(57) ABSTRACT

A brake caliper (100) includes a bolt guide (110) for axially displacing the brake caliper (100) on a brake carrier. A bolt (122) is received axially displaceably in the bolt guide (110), the bolt (122) having a bushing (124) arranged around the bolt (122). In addition to the bushing (124) and adjacent thereto, the brake caliper (100) has at least one damping element (130), the damping element (130) circumferentially surrounding the bolt (122) and being designed to damp a relative movement in the radial direction between the bolt (122) and the bolt guide (110). A kit for a bolt guide (110) of a brake caliper (100) includes the bolt, the bushing, and the damping element.

### FIELD

The present disclosure relates to a brake caliper for a vehicle brake, in particular a commercial vehicle disc brake, including a bolt guide for axially displacing the brake caliper on a brake carrier, and a bolt axially displaceably received in the bolt guide, the bolt having a bushing arranged around the bolt.

### BACKGROUND

Noises are generated within the bolt guide of the vehicle brake, in particular rattling noises. These are often disturbing. This is particularly the case with vehicle brakes in buses, where the brakes are often installed directly underneath the driver's seat or the seats of vehicle passengers. The noises are the result of a large radial play on the bolt side of the vehicle brake. This radial play is caused by the compensation of part tolerances.

### SUMMARY

The object of the present disclosure is to address at least one of the above-mentioned disadvantages, in particular to provide a brake caliper in which the noise emission is reduced during use.

The object is achieved in a first aspect by a brake caliper of the type mentioned at the outset, wherein the brake caliper has at least one damping element in addition to the bushing and adjacent thereto, the damping element circumferentially surrounding the bolt and being designed to damp a relative movement in the radial direction between the bolt and the bolt guide. The damping element is designed to limit the radial play or the overall play of the components, which is caused by the individual part tolerances. This is a simple and cost-effective solution to the problem. The damping element can be integrated into the known brake caliper without significantly modifying it.

Preferably, the damping element is arranged adjacently to the bushing, in particular the damping element is arranged at least in portions in contact with the bushing. The damping element can be in contact with the bushing, or in contact with it in portions, or can be arranged at a distance from the bushing.

Preferably, the brake caliper has a sealing element, the damping element being part of the sealing element. The sealing element is arranged at an outer end of the bolt and encloses it sealingly. It protects the bolt guide from external influences, in particular from dirt and moisture. The sealing element is made of an elastomeric material. The damping element is integrally arranged on the sealing element as an axial extension thereof. Preferably, a hollow-cylindrical damping element is integrally connected to the sealing element. This is a simple way of integrating an additional element into the brake caliper without significantly increasing the assembly effort.

Preferably, an inner contour of the damping element, in particular in the unmounted state, is oval-shaped, in particular circular or elliptical in cross-section, the damping element in particular having a hollow-cylindrical shape at least in portions. If the damping element has a hollow-cylindrical shape, the cross-section of the inner contour of the damping element is circular. When mounted, the damping element is arranged coaxially to the bolt. In particular, the elliptical shape is designed to bridge the radial play between the bolt and the bolt guide. Preferably, the outer contour of the damping element has the same shape as the inner contour of the damping element, so that the thickness of the damping element is constant. In a further embodiment, the inner contour can be elliptical and the outer contour circular or vice versa.

Preferably, the inner diameter of the damping element is smaller than the inner diameter of the bushing. The damping element has an annular cross-sectional area, the inner recess of the annular shape being designed to accommodate the bolt. The inner diameter is measured at a cross-sectional area of the recess. In the case of non-circular cross-sectional areas, the inner diameter is measured at the smallest diagonal of the cross-sectional area. If the cross-sectional area is not constant over the length of the damping element or bushing, the smallest diameter should be used for comparison.

Preferably, the damping element is partially or completely made of an elastomer, and the bushing is partially or completely made of a metal. The bushing should be as wear-resistant and stable as possible. For this reason, it is advantageous to integrate a further element, i.e., a damping element, in addition to the conventionally used bushing, which further element has a different material than the bushing. Elastomers are capable of reversibly taking up large deformations. Accordingly, they are designed to bridge tolerances and damp vibrations.

The damping element preferably has a reinforcing element, in particular the reinforcing element being partially or completely made of a metal. This increases the stability of the damping element. This can be advantageous when mounting the damping element on the bolt. In particular, the material of the reinforcing element has a higher rigidity than the elastomer material of the damping element. For example, a plastic, e.g., a thermoset, or a composite material can be used instead of a metal. The reinforcing element can have the form of rods or can be designed as a ring or platelet. If the brake caliper has a plurality of damping elements, all of the damping elements can have a reinforcing element, or some of the damping elements or none of the damping elements.

Preferably, the reinforcing element is arranged completely encased in the damping element. This prevents, to the greatest possible extent, damage to the bolt guide during assembly or during use within the guide.

Preferably, the damping element is a first damping element and the brake caliper additionally has a second damping element, the damping elements being arranged relative to the bushing on opposite sides of the bushing, preferably adjacently to the bushing. When using a second damping element, the damping property can be further increased. For example, largely constant damping over the length of the bolt guide is possible. An arrangement of the damping elements on opposite sides of the bushing means that the first damping element is positioned adjacently to the first end face of the bushing and the second damping element is positioned adjacently to the second end face of the bushing. One or both of the damping elements can also be arranged in direct contact with the bushing.

The present disclosure has been explained above with reference to the brake caliper according to the first aspect of the present disclosure. In a second aspect, the problem addressed by the present disclosure is solved by a kit for a bolt guide of a brake caliper according to one of the embodiments described above. The kit comprises a bolt and a bushing arranged coaxially around the bolt, the kit further comprising a damping element.

Preferred embodiments and advantages of the brake caliper according to the present disclosure are also preferred embodiments and advantages of the kits for such a brake caliper.

Exemplary embodiments of the present disclosure are now described below with reference to the drawings. These are not necessarily intended to show the exemplary embodiments to scale; rather, where useful for explanation, the drawings are in schematized and/or slightly distorted form. Reference is made to the relevant prior art with regard to additions to the teaching directly recognizable from the drawings. It should be noted that various modifications and changes can be made to the form and detail of an embodiment without departing from the general concept of the present disclosure. The features of the present disclosure disclosed in the description, in the drawings and in the claims may be essential both individually and in any combination for the development of the present disclosure. In addition, all combinations of at least two of the features disclosed in the description, the drawings and/or the claims fall within the scope of the present disclosure. The general concept of the present disclosure is not limited to the exact form or detail of the preferred embodiments presented and described below, or limited to any subject matter that would be restricted as compared to the subject matter claimed in the claims. In the case of stated dimension ranges, values lying within the stated limits are also to be disclosed as limit values and can be used and claimed as desired. For the sake of simplicity, like reference signs are used hereinafter for identical or similar parts or parts having identical or similar functions.

### BRIEF DESCRIPTION OF THE DRAWINGS

Further advantages, features and details of the present disclosure can be found in the following description of the preferred embodiments and in the following figures, in which:

FIG. 1 is a cross-sectional side view of the brake caliper according to a first embodiment;

FIG. 2 is an enlarged ross-sectional detailed view of the brake caliper according to a second embodiment;

FIG. 3 is a cross-sectional side view of the brake caliper according to a third embodiment; and

FIG. 4 is an end view of a damping element in one embodiment.

### DETAILED DESCRIPTION

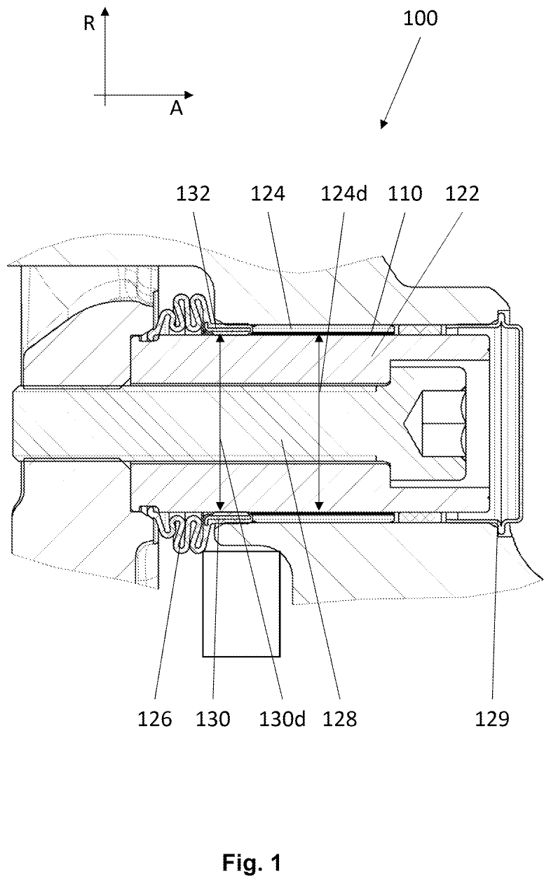

FIGS. 1 to 3 each show a cross-sectional side schematic detailed view of a brake caliper 100. The brake caliper 100 has a bolt guide 110, which is formed as a recess or bore in the brake caliper 100.

The bolt guide 110 is designed for axial displacement of the brake caliper 100 on a brake carrier (not shown).

A bolt 122 is axially displaceably accommodated in the bolt guide 110. The axial direction is indicated by the arrow A.

The bolt guide 110 is covered from the outside by a cover 129.

A bushing 124 is arranged around the bolt 122. The bolt 122 is arranged coaxially to the bushing 124, so that the bushing 124 surrounds the bolt 122 circumferentially.

The brake caliper 100 additionally has a damping element 130 in addition to the bushing 124 and adjacent thereto.

The damping element 130 is arranged around the bolt 122. The bolt 122 is arranged coaxially to the damping element 130, so that the damping element 130 circumferentially surrounds the bolt 122.

The damping element 130 has a shorter length than the bolt 122. Further, the bolt 122 has a greater length than a cumulative length of the damping element 130 and the bushing 124.

The damping element 130 is designed to damp a relative movement in the radial direction, characterized by the arrow R, between the bolt 122 and the bolt guide 110.

The damping element 130 is arranged adjacently to the bushing 124. In these exemplary embodiments, an end face of the damping element 130 is arranged adjacently to an end face of the bushing 124. The end faces can also be arranged in direct contact with one another.

The damping element 130 is made of an elastomer. The bushing 124 is made of a metal.

Furthermore, the inner diameter 130d of the damping element 130 is smaller than the inner diameter 124d of the bushing 124.

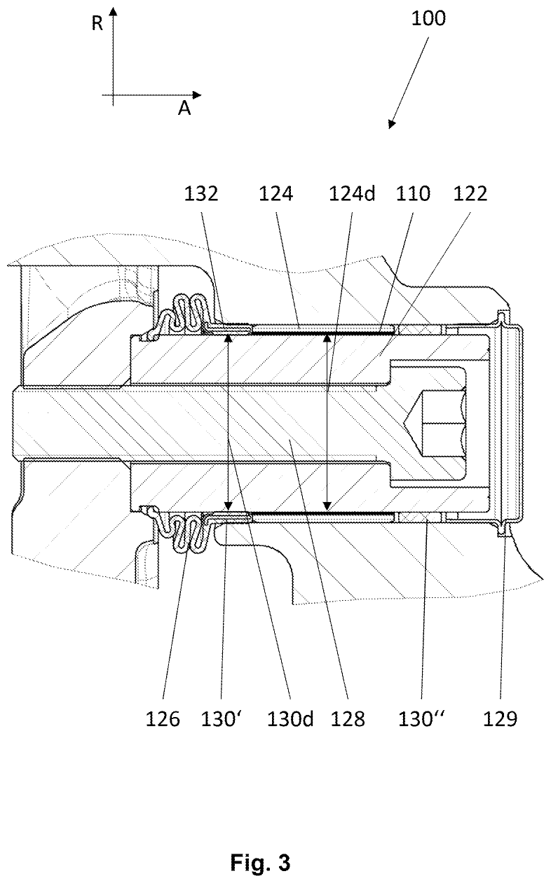

As shown in particular in FIGS. 1 and 3, the damping element 130 has a reinforcing element 132 in one embodiment. In another embodiment, the damping element 130 has no reinforcing element 132. The reinforcing element 132 is a metal ring or a metal rod, which is embedded in the damping element 130.

According to a first exemplary embodiment, see FIG. 1 in this regard, the brake caliper 100 further includes a sealing element 126. The sealing element 126 is arranged at an outer end of the bolt 122, preferably at an end opposite the end at which the head of a cheese head screw 128 is arranged. The cheese head screw 128 is arranged in the bolt 122. The damping element 130 is a part of the sealing element 126. In further embodiments, not shown, the brake caliper 100 includes a plurality of, preferably two, sealing elements. Preferably, the damping element 130 is a part of the second sealing element.

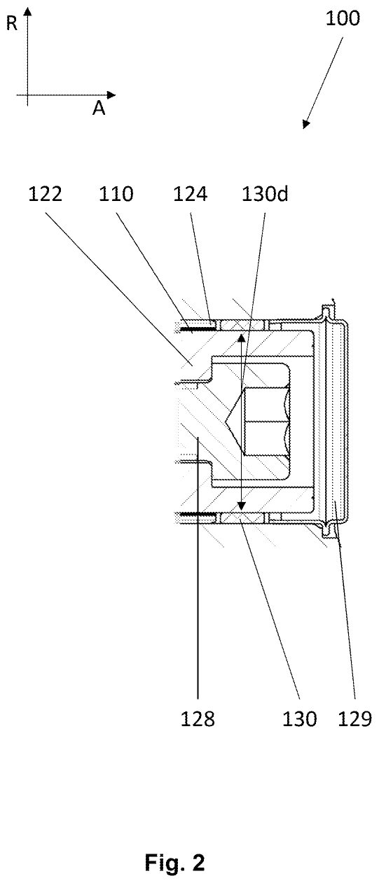

According to a second exemplary embodiment, which can be implemented as an alternative to the first exemplary embodiment (see FIG. 2 in this regard), the brake caliper 100 has a damping element 130 arranged adjacently to the bushing 124 and adjacently to the cover 129. The damping element 130 is designed as a single component.

According to a third exemplary embodiment (see FIG. 3 in this regard), the brake caliper 100 has a first damping element 130′ and additionally a second damping element 130″. The exemplary embodiments in FIGS. 1 and 2 are combined. The damping elements 130′, 130″ are arranged relative to the bushing 124 on opposite sides of the bushing 124. The first damping element 130′ is arranged adjacently to a first end face of the bushing 124. The third exemplary embodiment further includes the sealing element 126 according to the first exemplary embodiment. Preferably, the first damping element 130′ is integrally formed on the sealing element 126. The second damping element 130′ is arranged adjacently to the second end face of the bushing 124. The second damping element 130′ is also arranged adjacently to the cover 129.

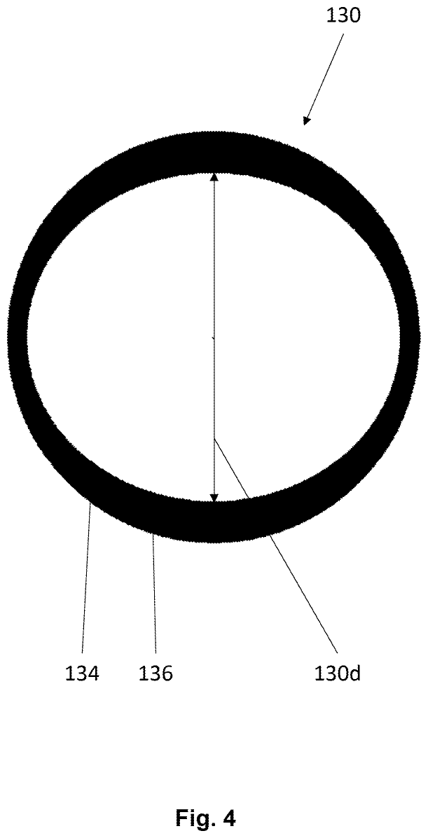

FIG. 4 shows a damping element 130, 130′, 130″ for use with the exemplary embodiments in an unmounted, non-deformed state. The inner contour 134 of the damping element 130 is oval-shaped in cross-section. In this exemplary embodiment, the damping element 130 has an elliptical inner contour 134. Furthermore, the cross-sectional area of the damping element 130 is annular. The outer contour 136 of the damping element 130 is circular. Thus, the thickness varies along the cross-sectional area along the circumference. In other embodiments, the damping element 130 may have a hollow-cylindrical shape, at least in portions. With the oval-shaped inner contour 134, the inner diameter of the damping element 130d in this exemplary embodiment is the smallest diameter of the cross-sectional area.

### LIST OF REFERENCE SIGNS (PART OF THE DESCRIPTION)

100 brake caliper
110 bolt guide
122 bolt
124 socket
124d inner diameter of the bushing
126 sealing element
128 cheese head screw
129 cover
130 damping element
130d inner diameter of the damping element
130′ first damping element
130″ second damping element
132 reinforcing element
134 inner contour
136 outer contour
A axial direction
R radial direction

What is claimed is:

1. A brake caliper (100) for a vehicle brake, comprising:
a bolt guide (110) for axially displacing the brake caliper (100) on a brake carrier, and
a bolt (122) axially displaceably received in the bolt guide (110),
the bolt (122) including a bushing (124) arranged around the bolt (122),
wherein the brake caliper (100) has at least one damping element (130) in addition to the bushing (124) and adjacent to the bushing (124),
wherein the damping element (130) circumferentially surrounds the bolt (122) and damps damp a relative movement in the radial direction between the bolt (122) and the bolt guide (110).

2. The brake caliper (100) as claimed in claim 1,
wherein the damping element (130) is arranged adjacent to the bushing (124) in portions in contact with the bushing (124).

3. The brake caliper (100) as claimed in claim 1,
wherein the brake caliper (100) includes a sealing element (126), wherein the damping element (130) is part of the sealing element (126).

4. The brake caliper (100) as claimed in claim 1,
wherein an inner contour (134) of the damping element (130), in an unmounted state, is oval-shaped in cross-section.

5. The brake caliper (100) as claimed in claim 1,
wherein an inner diameter (130d) of the damping element (130) is smaller than an inner diameter (124d) of the bushing (124).

6. The brake caliper (100) as claimed in claim 1,
wherein the damping element (130) is formed partially or completely from an elastomer, wherein the bushing (124) is formed partially or completely from a metal.

7. The brake caliper (100) as claimed in claim 1,
wherein the damping element (130) has a reinforcing element (132), wherein the reinforcing element (132) is formed partially or completely from a metal.

8. The brake caliper (100) as claimed in claim 7,
wherein the reinforcing element (132) is completely encased in the damping element (130).

9. The brake caliper (100) as claimed in claim 1,
wherein the damping element is a first damping element (130′) and the brake caliper (100) additionally includes a second damping element (130″), the damping elements (130, 130′, 130″) being arranged relative to the bushing (124) on opposite sides of the bushing (124) and adjacent to the bushing (124).

10. A kit for a bolt guide (110) of a brake caliper (100), comprising:
a bolt (122),
a bushing (124) arranged around the bolt (122), and
a damping element (130);
wherein the damping element is configured to circumferentially surround the bolt adjacent the bushing and is configured to damp the bolt (122) in a radial direction relative to a bolt guide of the brake caliper in which the bolt, the bushing, and the damping element are received.

11. The brake caliper (100) as claimed in claim 1,
wherein the damping element (130) is arranged adjacent to the bushing (124) in contact with the bushing (124).

12. The brake caliper (100) as claimed in claim 1, wherein the damping element (130) is arranged adjacent to the bushing (124) at a distance from the bushing (124).

13. The brake caliper 100 as claimed in claim 3, wherein the damping element is integrally arranged on the sealing element as an axial extension of the sealing element.

14. The brake caliper (100) as claimed in claim 4, wherein cross-section of the inner contour is elliptical.

15. The brake caliper (100) as claimed in claim 1, wherein the damping element bridges a radial play between the bolt and the bolt guide.

16. The brake caliper (100) as claimed in claim 9, wherein one or both of the damping elements are arranged in direct contact with an axial end face of the bushing.

17. The brake caliper (100) as claimed in claim 1, wherein the bolt has a greater length than a cumulative length of the bushing and the damping element.

18. The brake caliper (100) as claimed in claim 4, wherein the inner contour is elliptical and an outer contour of the damping element is circular, and a thickness of the damping element varies along a cross-sectional area of the damping element.

19. The brake caliper (100) as claimed in claim 1, wherein the damping element is arranged adjacent the bushing and an outer cover (129) of the brake caliper.

20. The brake caliper (100) as claimed in claim 9, wherein the first damping element is adjacent a first end face of the bushing and is integral with a sealing element (126) arranged at first end of the bolt, and the second damping element is arranged at second end face opposite the first end face and adjacent an outer cover (129) of the bolt guide.
